(19) United States
(12) Patent Application Publication
(10) Pub. No.: US 2025/0013595 A1
(43) Pub. Date: Jan. 9, 2025

(54) DEVICE CONTROL METHOD, MEMORY STORAGE DEVICE AND MEMORY CONTROL CIRCUIT UNIT

(71) Applicant: PHISON ELECTRONICS CORP., Miaoli (TW)

(72) Inventors: Yuwei Kuo, Hsinchu City (TW); Yun-You Lin, Kaohsiung City (TW); Jhen-Ting Li, Taoyuan City (TW); Christopher Ramseyer, Mooresville, IN (US)

(73) Assignee: PHISON ELECTRONICS CORP., Miaoli (TW)

(21) Appl. No.: 18/450,411

(22) Filed: Aug. 16, 2023

(30) Foreign Application Priority Data
Jul. 7, 2023 (TW) 112125572

(51) Int. Cl. G06F 13/42; G06F 13/38

(52) U.S. Cl. CPC G06F 13/4234; G06F 13/385; G06F 13/4221

(57) ABSTRACT

A device control method, a memory storage device, and a memory control circuit unit are disclosed. The method includes: obtaining device status information of the memory storage device, and the device status information includes at least one of temperature information and power consumption information; and adjusting a connection interface standard adopted by a connection interface unit of the memory storage device from a first connection interface standard to a second connection interface standard according to the device status information, and the first connection interface standard is different from the second connection interface standard.

### CROSS-REFERENCE TO RELATED APPLICATION

This application claims the priority benefit of Taiwan application serial no. 112125572, filed on Jul. 7, 2023. The entirety of the above-mentioned patent application is hereby incorporated by reference herein and made a part of this specification.

### BACKGROUND OF THE INVENTION

### Field of the Invention

The invention relates to a device control method, a memory storage device, and a memory control circuit unit.

### Description of Related Art

Portable electronic devices such as mobile phones and notebook computers have grown rapidly in the past few years, which has led to a rapid increase in consumer demand for storage media. Since a rewritable non-volatile memory module (such as a flash memory) has characteristics such as data non-volatility, power-saving, small size, and lack of mechanical structures, the rewritable non-volatile memory module is very suitable to be built into the various portable electronic devices provided above.

With the advancement of technology, users have gradually increased requirements on the data transfer speed between the memory storage device and the host system. Taking the Peripheral Component Interconnect Express (PCI Express) standard as an example, from the first generation (Gen 1) to the fifth generation (Gen 5) of the PCI Express standard, the supported data transfer speed has increased significantly. However, as the data transfer speed between the memory storage device and the host system is increased, adverse effects on the memory storage device and the host system include temperature rise of the device and increased power consumption of the device. Therefore, how to achieve balance among the temperature, power consumption, and data transfer speed of the memory storage device, so as to improve the operating stability of the memory storage device, is actually one of the topics that researchers in the art are devoted to research.

### SUMMARY OF THE INVENTION

The invention provides a device control method, a memory storage device, and a memory control circuit unit that may improve the operating stability of the memory storage device.

An exemplary embodiment of the invention provides a device control method, configured for a memory storage device, wherein the memory storage device includes a connection interface unit, the connection interface unit is configured to be coupled to a host system, and the device control method includes: obtaining device status information of the memory storage device, wherein the device status information includes at least one of temperature information and power consumption information; and adjusting a connection interface standard adopted by the connection interface unit from a first connection interface standard to a second connection interface standard according to the device status information, wherein the first connection interface standard is different from the second connection interface standard.

An exemplary embodiment of the invention further provides a memory storage device including a connection interface unit, a rewritable non-volatile memory module, and a memory control circuit unit. The connection interface unit is configured to be coupled to a host system. The memory control circuit unit is coupled to the connection interface unit and the rewritable non-volatile memory module, wherein the memory control circuit unit is configured to: obtain device status information of the memory storage device, wherein the device status information includes at least one of temperature information and power consumption information; and adjust a connection interface standard adopted by the connection interface unit from the first connection interface standard to the second connection interface standard according to the device status information, wherein the first connection interface standard is different from the second connection interface standard.

An exemplary embodiment of the invention further provides a memory control circuit unit configured to control a memory storage device, wherein the memory storage device includes a connection interface unit, the connection interface unit is coupled to a host system, and the memory control circuit unit includes a host interface, a memory interface, and a memory management circuit. The host interface is configured to be coupled to the host system. The memory interface is configured to be coupled to the rewritable non-volatile memory module. The memory management circuit is coupled to the host interface and the memory interface, wherein the memory management circuit is configured to: obtain device status information of the memory storage device, wherein the device status information includes at least one of temperature information and power consumption information; and adjust a connection interface standard adopted by the connection interface unit from the first connection interface standard to the second connection interface standard according to the device status information, wherein the first connection interface standard is different from the second connection interface standard.

Based on the above, after the device status information of the memory storage device is obtained, according to at least one of temperature information and power consumption information in the device status information, the connection interface standard adopted by the connection interface unit of the memory storage device may be adjusted. Thereby, balance may be achieved among the temperature, power consumption, and data transfer speed of the memory storage device as much as possible, thereby improving the operating stability of the memory storage device.

### BRIEF DESCRIPTION OF THE DRAWINGS

FIG. 1 is a schematic diagram of a host system, a memory storage device, and an input/output (I/O) device shown according to an exemplary embodiment of the invention.

FIG. 2 is a schematic diagram of a host system, a memory storage device, and an I/O device shown according to an exemplary embodiment of the invention.

FIG. 3 is a schematic diagram of a host system and a memory storage device shown according to an exemplary embodiment of the invention.

FIG. 4 is a schematic block diagram of a memory storage device shown according to an exemplary embodiment of the invention.

FIG. 5 is a schematic block diagram of a memory control circuit unit shown according to an exemplary embodiment of the disclosure.

FIG. 6 is a schematic diagram of the management of a rewritable non-volatile memory module shown according to an exemplary embodiment of the invention.

FIG. 7 is a schematic diagram of basic specifications of various connection interface standards shown according to an exemplary embodiment of the invention.

FIG. 8 is a schematic diagram of adjusting a connection interface standard adopted by a connection interface unit shown according to an exemplary embodiment of the invention.

FIG. 9 is a schematic diagram of further adjusting the upper limit of data transfer per unit time when a specific connection interface standard is adopted shown according to an exemplary embodiment of the invention.

FIG. 10 is a flowchart of a device control method shown according to an exemplary embodiment of the invention.

FIG. 11 is a flowchart of a device control method shown according to an exemplary embodiment of the invention.

### DESCRIPTION OF THE EMBODIMENTS

In general, a memory storage device (also referred to as a memory storage system) includes a rewritable non-volatile memory module and a controller (also referred to as a control circuit). The memory storage device may be used with a host system, such that the host system may write data into the memory storage device or read data from the memory storage device.

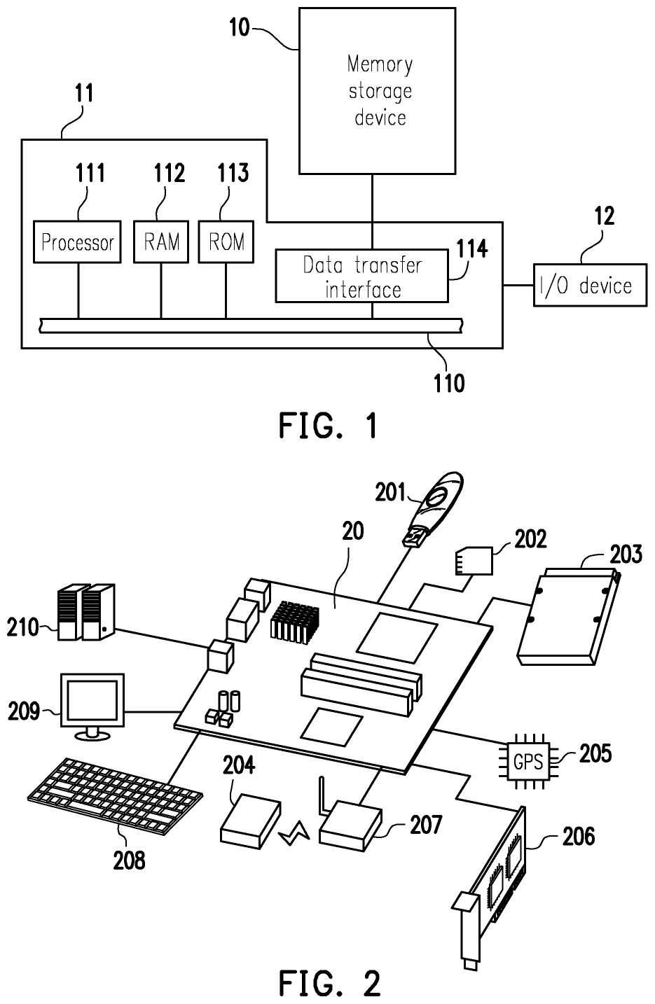

FIG. 1 is a schematic diagram of a host system, a memory storage device, and an input/output (I/O) device shown according to an exemplary embodiment of the invention. FIG. 2 is a schematic diagram of a host system, a memory storage device, and an I/O device shown according to an exemplary embodiment of the invention.

Referring to FIG. 1 and FIG. 2, a host system 11 may include a processor 111, a random-access memory (RAM) 112, a read-only memory (ROM) 113, and a data transfer interface 114. The processor 111, the RAM 112, the ROM 113, and the data transfer interface 114 may be coupled to a system bus 110.

In an exemplary embodiment, the host system 11 may be coupled to the memory storage device 10 via the data transfer interface 114. For example, the host system 11 may store data into the memory storage device 10 or read data from the memory storage device 10 via the data transfer interface 114. Moreover, the host system 11 may be coupled to the I/O device 12 via the system bus 110. For example, the host system 11 may send an output signal to the I/O device 12 or receive an input signal from the I/O device 12 via the system bus 110.

In an exemplary embodiment, the processor 111, the RAM 112, the ROM 113, and the data transfer interface 114 may be disposed on a motherboard 20 of the host system 11. The quantity of the data transfer interface 114 may be one or a plurality. The motherboard 20 may be coupled to the memory storage device 10 in a wired or wireless method via the data transfer interface 114.

In an exemplary embodiment, the memory storage device 10 may be, for example, a flash drive 201, a memory card 202, a solid-state drive (SSD) 203, or a wireless memory storage device 204. The wireless memory storage device 204 may be, for example, a memory storage device based on various wireless communication techniques such as a near-field communication (NFC) memory storage device, a wireless fax (WiFi) memory storage device, a Bluetooth memory storage device, or a low-power Bluetooth memory storage device (such as iBeacon). Moreover, the motherboard 20 may also be coupled to various I/O devices such as a global positioning system (GPS) module 205, a network interface card 206, a wireless transfer device 207, a keyboard 208, a screen 209, or a speaker 210 via the system bus 110. For example, in an exemplary embodiment, the motherboard 20 may access the wireless memory storage device 204 via the wireless transfer device 207.

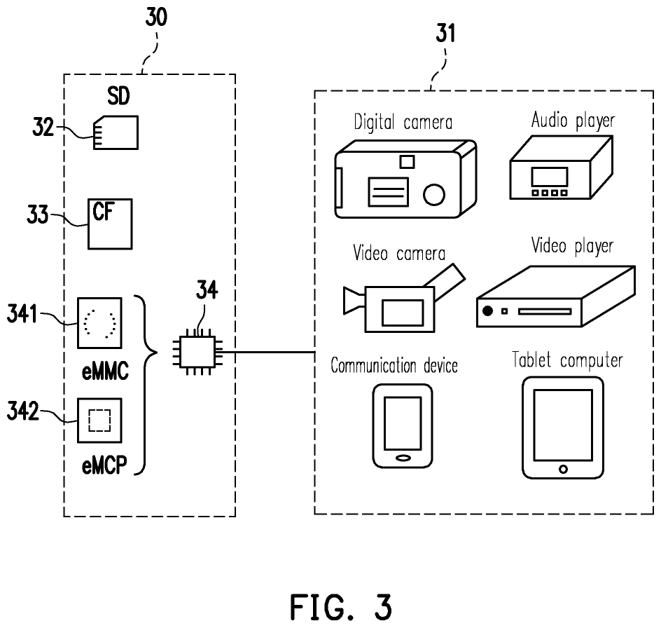

In an exemplary embodiment, the host system 11 is a computer system. In an exemplary embodiment, the host system 11 may be any system that may substantially store data with the memory storage device. In an exemplary embodiment, the memory storage device 10 and the host system 11 may respectively include a memory storage device 30 and a host system 31 of FIG. 3.

FIG. 3 is a schematic diagram of a host system and a memory storage device shown according to an exemplary embodiment of the invention. Referring to FIG. 3, the memory storage device 30 may be used in conjunction with the host system 31 to store data. For example, the host system 31 may be a system such as a digital camera, a video recorder, a communication device, an audio player, a video player, or a tablet computer. For example, the memory storage device 30 may be various non-volatile memory storage devices such as a Secure Digital (SD) card 32, a Compact Flash (CF) card 33, or an embedded storage device 34 used by the host system 31. The embedded storage device 34 includes various types of embedded storage devices for which a memory module is directly coupled on the substrate of the host system, such as an embedded multimedia card (eMMC) 341 and/or an embedded multi-chip package (eMCP) storage device 342.

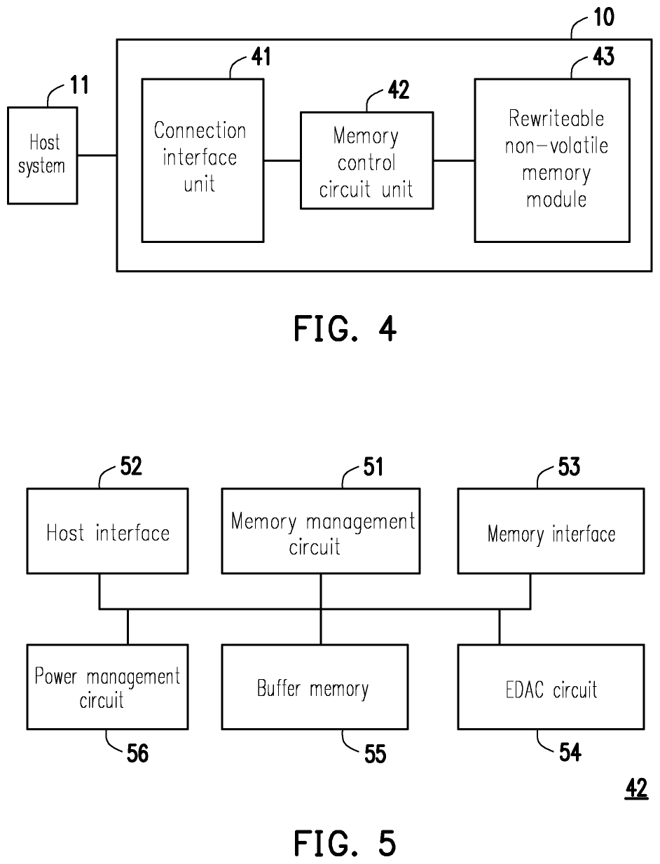

FIG. 4 is a schematic diagram of a memory storage device shown according to an exemplary embodiment of the invention. Referring to FIG. 4, the memory storage device 10 includes a connection interface unit 41, a memory control circuit unit 42, and a rewritable non-volatile memory module 43.

The connection interface unit 41 is configured to be coupled to the host system 11. The memory storage device 10 may be communicated with the host system 11 via the connection interface unit 41. In an exemplary embodiment, the connection interface unit 41 is compatible with the Peripheral Component Interconnect Express (PCI Express) standard. In an exemplary embodiment, the connection interface unit 41 may also be compatible with Serial Advanced Technology Attachment (SATA) standard, Parallel Advanced Technology Attachment (PATA) standard, Institute of Electrical and Electronic Engineers (IEEE) 1394 standard, Universal Serial Bus (USB) standard, SD interface standard, Ultra High Speed-I (UHS-I) interface standard, Ultra High Speed-II (UHS-II) interface standard, Memory Stick (MS) interface standard, MCP interface standard, MMC interface standard, eMMC interface standard, Universal Flash Storage (UFS) interface standard, eMCP interface standard, CF interface standard, Integrated Device Electronics (IDE) standard, or other suitable standards. The connection interface unit 41 may be sealed in a chip with the memory control circuit unit 42. Alternatively, the connection interface unit 41 is disposed outside of a chip containing the memory control circuit unit 42.

The memory control circuit unit 42 is coupled to the connection interface unit 41 and the rewritable non-volatile memory module 43. The memory control circuit unit 42 is configured to perform a plurality of logic gates or control commands implemented in a hardware form or in a firmware form. The memory control circuit unit 404 also performs operations such as writing, reading, and erasing data in the rewritable non-volatile memory storage module 43 according to the commands of the host system 11.

The rewritable non-volatile memory module 43 is configured to store the data written by the host system 11. The rewritable non-volatile memory module 43 may include a single-level cell (SLC) NAND-type flash memory module (that is, a flash memory module that may store 1 bit in one memory cell), a multi-level cell (MLC) NAND-type flash memory module (that is, a flash memory module that may store 2 bits in one memory cell), a triple-level cell (TLC) NAND-type flash memory module (i.e., a flash memory module that may store 3 bits in one memory cell), a quad-level cell (QLC) NAND-type flash memory module (that is, a flash memory module that may store 4 bits in one memory cell), other flash memory modules, or other memory modules with the same characteristics.

Each of the memory cells in the rewritable non-volatile memory module 43 stores one or a plurality of bits via the change in voltage (also referred to as threshold voltage hereinafter). Specifically, a charge-trapping layer is disposed between the control gate and the channel of each of the memory cells. By applying a write voltage to the control gate, the number of electrons of the charge-trapping layer may be changed, and therefore the threshold voltage of the memory cells may be changed. This operation of changing the threshold voltage of the memory cells is also referred to as “writing data to the memory cells” or “programming the memory cells”. As the threshold voltage is changed, each of the memory cells in the rewritable non-volatile memory module 43 has a plurality of storage statuses. Which storage status one memory cell belongs to may be determined via the application of a read voltage, so as to obtain one or a plurality of bits stored by the memory cell.

In an exemplary embodiment, the memory cells of the rewritable non-volatile memory module 43 may form a plurality of physical programming units, and the physical programming units may form a plurality of physical erasing units. Specifically, the memory cells on the same word line may form one or a plurality of physical programming units. If each of the memory cells may store 2 or more bits, the physical programming units on the same word line may be at least classified into lower physical programming units and upper physical programming units. For example, the least significant bit (LSB) of a memory cell belongs to the lower physical programming units, and the most significant bit (MSB) of a memory cell belongs to the upper physical programming units. Generally, in an MLC NAND-type flash memory, the write speed of the lower physical programming units is greater than the write speed of the upper physical programming units, and/or the reliability of the lower physical programming units is greater than the reliability of the upper physical programming units.

In an exemplary embodiment, the physical programming unit is the smallest unit of programming. That is, the physical programming unit is the smallest unit of data writing. For example, the physical programming unit may be a physical page or a physical sector. If the physical programming unit is a physical page, then the physical programming units may include a data bit area and a redundancy bit area. The data bit area contains a plurality of physical sectors configured to store user data, and the redundancy bit area is configured to store system data (for example, management data such as an error correcting code). In an exemplary embodiment, the data bit area includes 32 physical sectors, and the size of one physical sector is 512 bytes (B). However, in other exemplary embodiments, the data bit area may also contain 8, 16, or a greater or lesser number of physical sectors, and the size of each of the physical sectors may also be greater or smaller. Moreover, the physical erasing unit is the smallest unit of erasing. That is, each of the physical erasing units contains the smallest number of memory cells erased together. For example, the physical erasing unit is a physical block.

FIG. 5 is a schematic diagram of a memory control circuit unit shown according to an exemplary embodiment of the invention. Referring to FIG. 5, the memory control circuit unit 42 includes a memory management circuit 51, a host interface 52, and a memory interface 53.

The memory management circuit 51 is configured to control the overall operation of the memory control circuit unit 42. Specifically, the memory management circuit 51 has a plurality of control commands. During the operation of the memory storage device 10, the control commands are executed to perform operations such as writing, reading, and erasing data. In the following, descriptions relating to the operation of the memory management circuit 51 are equivalent to the descriptions of the operation of the memory control circuit unit 42.

In an exemplary embodiment, the control commands of the memory management circuit 51 are implemented in a firmware form. For example, the memory management circuit 51 has a microprocessor unit (not shown) and a read-only memory (not shown), and the control commands are burned into the ROM. During the operation of the memory storage device 10, the control commands are executed by the microprocessor unit to perform operations such as writing, reading, and erasing data.

In an exemplary embodiment, the control commands of the memory management circuit 51 may also be stored in a specific area of the rewritable non-volatile memory module 43 (for example, a system area dedicated to storing system data in the memory module) in the form of program codes. Moreover, the memory management circuit 51 has a microprocessor unit (not shown), a ROM (not shown), and a RAM (not shown). In particular, the ROM has a boot code, and when the memory control circuit unit 42 is enabled, the microprocessor unit first executes the boot code to load the control commands stored in the rewritable non-volatile memory module 43 into the RAM of the memory management circuit 51. Next, the microprocessor unit runs the control commands to perform operations such as writing, reading, and erasing data.

In an exemplary embodiment, the control commands of the memory management circuit 51 may also be implemented in a hardware form. For example, the memory management circuit 51 includes a microcontroller, a memory cell management circuit, a memory write circuit, a memory read circuit, a memory erase circuit, and a data processing circuit. The memory cell management circuit, the memory write circuit, the memory read circuit, the memory erase circuit, and the data processing circuit are coupled to the microcontroller. The memory cell management circuit is configured to manage memory cells or memory cell groups of the rewritable non-volatile memory module 43. The memory write circuit is configured to issue a write command sequence to the rewritable non-volatile memory module 43 to write data into the rewritable non-volatile memory module 43. The memory read circuit is configured to issue a read command sequence to the rewritable non-volatile memory module 43 to read data from the rewritable non-volatile memory module 43. The memory erase circuit is configured to issue an erase command sequence to the rewritable non-volatile memory module 43 to erase data from the rewritable non-volatile memory module 43. The data processing circuit is configured to process the data to be written into the rewritable non-volatile memory module 43 and the data read from the rewritable non-volatile memory module 43. The write command sequence, the read command sequence, and the erase command sequence may independently include one or a plurality of program codes or command codes and be configured to instruct the rewritable non-volatile memory module 43 to perform corresponding operations such as writing, reading, and erasing. In an exemplary embodiment, the memory management circuit 51 may also issue other types of command sequences to the rewritable non-volatile memory module 43 to instruct the performance of corresponding operations.

The host interface 52 is coupled to the memory management circuit 51. The memory management circuit 51 may be communicated with the host system 11 via the host interface 52. The host interface 52 may be configured to receive and identify commands and data sent by the host system 11. For example, the commands and data sent by the host system 11 may be sent to the memory management circuit 51 via the host interface 52. In addition, the memory management circuit 51 may send data to the host system 11 via the host interface 52. In the present exemplary embodiment, the host interface 52 is compatible with the PCI Express standard. However, it should be understood that the invention is not limited thereto, and the host interface 52 may also be compatible with the SATA standard, PATA standard, IEEE 1394 standard, USB standard, SD standard, UHS-I standard, UHS-II standard, MS standard, MMC standard, eMMC standard, UFS standard, CF standard, IDE standard, or other suitable standards for data transfer.

The memory interface 53 is coupled to the memory management circuit 51 and configured to access the rewritable non-volatile memory module 43. For example, the memory management circuit 51 may access the rewritable non-volatile memory module 43 via the memory interface 53. That is, the data to be written into the rewritable non-volatile memory module 43 is converted into a format acceptable to the rewritable non-volatile memory module 43 via the memory interface 53. Specifically, if the memory management circuit 51 is to access the rewritable non-volatile memory module 43, the memory interface 53 transmits the corresponding command sequence. For example, the command sequence may include a write command sequence instructing data writing, a read command sequence instructing data reading, an erase command sequence instructing data erasing, and corresponding command sequences configured to instruct various memory operations (such as changing read voltage level or performing a garbage collection (CC) operation). The command sequences are generated by, for example, the memory management circuit 51 and sent to the rewritable non-volatile memory module 43 via the memory interface 53. The command sequences may include one or a plurality of signals or data on a bus. The signals or data may include command codes or program codes. For example, when reading a command sequence, information such as read identification code or memory address is included.

In an exemplary embodiment, the memory control circuit unit 42 further includes an error detecting and correcting circuit 54, a buffer memory 55, and a power management circuit 56.

The error detection and correction circuit 54 is coupled to the memory management circuit 51 and is configured to execute an error detection and correction operation to ensure the correctness of data. Specifically, when the memory management circuit 51 receives a write command from the host system 11, the error detection and correction circuit 54 generates a corresponding error correcting code (ECC) and/or error detecting code (EDC) for the data corresponding to the write command, and the memory management circuit 51 writes the data corresponding to the write command and the corresponding ECC and/or EDC into the rewritable non-volatile memory module 43. Next, when data is read from the rewritable non-volatile memory module 43, the memory management circuit 51 reads the ECC and/or the EDC corresponding to the data at the same time, and the error detection and correction circuit 54 executes an error detection and correction operation on the read data based on the ECC and/or the EDC.

The buffer memory 55 is coupled to the memory management circuit 51 and configured to temporarily store data. The power management circuit 56 is coupled to the memory management circuit 51 and configured to control the power of the memory storage device 10.

In an exemplary embodiment, the rewritable non-volatile memory module 43 of FIG. 4 may include a flash memory module. In an exemplary embodiment, the memory control circuit unit 42 of FIG. 4 may include a flash memory controller. In an exemplary embodiment, the memory management circuit 51 of FIG. 5 may include a flash memory management circuit.

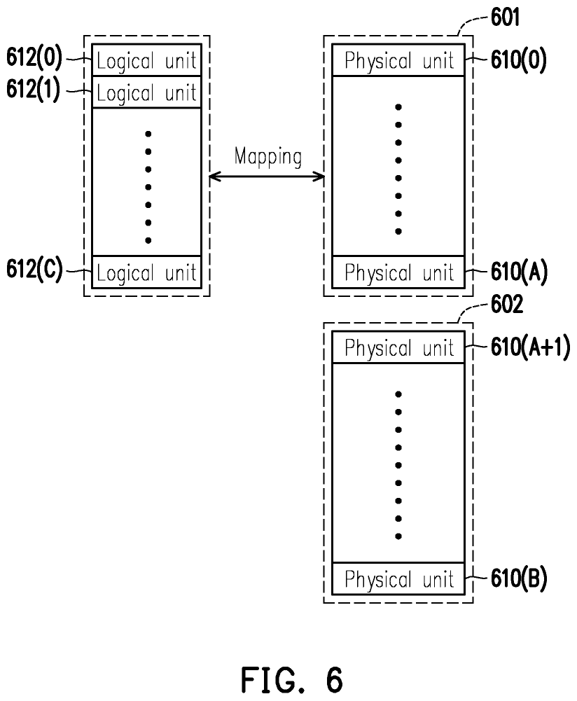

FIG. 6 is a schematic diagram of the management of a rewritable non-volatile memory module shown according to an exemplary embodiment of the invention. Referring to FIG. 6, the memory management circuit 51 may logically group physical units 610(0) to 610(B) in the rewritable non-volatile memory module 43 into a storage area 601 and a spare area 602.

In an exemplary embodiment, one physical unit refers to one physical address or one physical programming unit. In an exemplary embodiment, one physical unit may also be formed by a plurality of continuous or discontinuous physical addresses. In an exemplary embodiment, one physical unit may also refer to one virtual block (VB). One virtual block may include a plurality of physical addresses or a plurality of physical programming units. In an exemplary embodiment, one virtual block may include one or a plurality of physical erasing units.

The physical units 610(0) to 610(A) in the storage area 601 are configured to store user data (for example, user data from the host system 11 in FIG. 1). For example, the physical units 610(0) to 610(A) in the storage area 601 may store valid data and invalid data. The physical units 610(A+1) to 610(B) in the spare area 602 do not store data (e.g., valid data). For example, if a certain physical unit does not store valid data, then this physical unit may be associated with (or added) to the spare area 602. In addition, the physical units (or physical units that do not store valid data) in the spare area 602 may be erased. When writing new data, one or a plurality of physical units may be extracted from the spare area 602 to store the new data. In an exemplary embodiment, the spare area 602 is also referred to as a free pool.

The memory management circuit 51 may configure logical units 612(0) to 612(C) to map the physical units 610(0) to 610(A) in the storage area 601. In an exemplary embodiment, each of the logical units corresponds to one logical address. For example, one logical address may include one or a plurality of logical block addresses (LBAs) or other logical management units. In an exemplary embodiment, one logical unit may also correspond to one logic programming unit or be formed by a plurality of continuous or discontinuous logical addresses.

It should be noted that one logical unit may be mapped to one or a plurality of physical units. If a certain physical unit is currently mapped by a certain logical unit, the data currently stored in this physical unit includes valid data. On the other hand, if a certain physical unit is not currently mapped by any logical unit, the data currently stored in this physical unit is invalid data.

The memory management circuit 51 may record the management data describing the mapping relationship between logical units and physical units (also called logical-to-physical mapping information) in at least one logical-to-physical mapping table. When the host system 11 is to read data from the memory storage device 10 or write data to the memory storage device 10, the memory management circuit 51 may access the rewritable non-volatile memory module 43 according to the information in the logical-to-physical mapping table.

In an exemplary embodiment, the memory management circuit 51 may obtain device status information of the memory storage device 10. The device status information may include at least one of temperature information, power consumption information, and performance information. In an exemplary embodiment, the device status information may refer to any one of temperature information, power consumption information, and performance information. In an exemplary embodiment, the device status information may refer to any two of temperature information, power consumption information, and performance information. In an exemplary embodiment, the device status information may refer to temperature information, power consumption information, and performance information. In an exemplary embodiment, the device status information may further include other information to reflect whether the memory storage device 10 is in a specific status, the working status of the memory storage device 10, and/or whether the memory storage device 10 is performing a specific operation, and the like, and the invention is not limited thereto.

In an exemplary embodiment, the temperature information may reflect the temperature of the memory storage device 10. For example, the temperature information may be measured in real time by a temperature sensor (not shown) disposed inside the memory storage device 10. For example, the temperature information may reflect the temperature of at least one of the connection interface unit 41, the memory control circuit unit 42, and the rewritable non-volatile memory module 43. In an exemplary embodiment, if the memory storage device 10 has a volatile memory module, such as a dynamic random-access memory (DRAM) and/or a static random-access memory (SRAM), the temperature information may also reflect the temperature of the volatile memory module.

In an exemplary embodiment, the power consumption information may reflect the power consumption per unit time of the memory storage device 11. For example, the power consumption information may be measured in real time by a current meter and/or a power meter (not shown) disposed inside the memory storage device 10.

In an exemplary embodiment, the performance information may reflect the data transfer per unit time between the memory storage device 10 and the host system 11. For example, the performance information may be obtained by monitoring the data transfer status of the connection interface unit 41. In an exemplary embodiment, the data transfer per unit time between the memory storage device 10 and the host system 11 is also referred to as the data transfer per unit time (or data transfer speed) of the memory storage device 10 (or the connection interface unit 41).

In an exemplary embodiment, the memory management circuit 51 may adjust the connection interface standard adopted by the connection interface unit 41 according to the device status information. For example, the memory management circuit 51 may adjust the connection interface standard adopted by the connection interface unit 41 from a certain connection interface standard (also called the first connection interface standard) to another connection interface standard (also called the second connection interface standard) according to the device status information. The first connection interface standard is different from the second connection interface standard.

In an exemplary embodiment, when the connection interface unit 41 adopts the first connection interface standard, the memory storage device 10 may have a specific upper limit of data transfer per unit time (also referred to as a first upper limit of data transfer per unit time). When the connection interface unit 41 adopts the second connection interface standard, the memory storage device 10 may have another upper limit of data transfer per unit time (also referred to as a second upper limit of data transfer per unit time). The first upper limit of data transfer per unit time is different from the second upper limit of data transfer per unit time. For example, the first upper limit of data transfer per unit time may be higher or lower than the second upper limit of data transfer per unit time.

In an exemplary embodiment, the upper limit of data transfer per unit time is also referred to as the upper limit of transfer speed. In an exemplary embodiment, the upper limit of data transfer per unit time may reflect the maximum value of data transfer per unit time allowed between the memory storage device 10 and the host system 11. Moreover, the data transfer per unit time between the memory storage device 10 and the host system 11 may be directly related to the temperature (or heat generation per unit time) and/or power consumption (or power consumption per unit time) of the memory storage device 10.

In an exemplary embodiment, the connection interface standard that may be adopted by the connection interface unit 41 may include at least two of first generation (Gen 1), second generation (Gen 2), third generation (Gen 3), fourth generation (Gen 4), and fifth generation (Gen 5) of the PCI Express standard. Therefore, in an exemplary embodiment, the first connection interface standard may be one of PCI Express Gen 1, Gen 2, Gen 3, Gen 4, and Gen 5, and the second connection interface standard may be another one of PCI Express Gen 1, Gen 2, Gen 3, Gen 4, and Gen 5. In an exemplary embodiment, the connection interface unit 41 may also adopt other types of connection interface standards, and the invention is not limited thereto.

In an exemplary embodiment, according to the device status information, the memory management circuit 51 may also enable or disable at least one circuit in the connection interface unit 41. For example, in response to the connection interface standard adopted by the connection interface unit 41 being adjusted to the second connection interface standard, the memory management circuit 51 may enable or disable at least one circuit in the connection interface unit 41 to satisfy the equalizer setting of the connection interface unit 41 under the second connection interface standard. In an exemplary embodiment, the setting of the equalizer connected to the connection interface unit 41 may also affect the temperature (or heat generation per unit time) and/or power consumption (or power consumption per unit time) of the memory storage device 10.

In an exemplary embodiment, according to the device status information, the memory management circuit 51 may also adjust the coding rule adopted by the connection interface unit 41. For example, in response to the connection interface standard adopted by the connection interface unit 41 being adjusted to the second connection interface standard, the memory management circuit 51 may adjust the coding rule adopted by the connection interface unit 41 to meet the specification of the connection interface unit 41 under the second connection interface standard. In an exemplary embodiment, the coding rule adopted by the connection interface unit 41 may also affect the temperature (or heat generation per unit time) and/or power consumption (or power consumption per unit time) of the memory storage device 10.

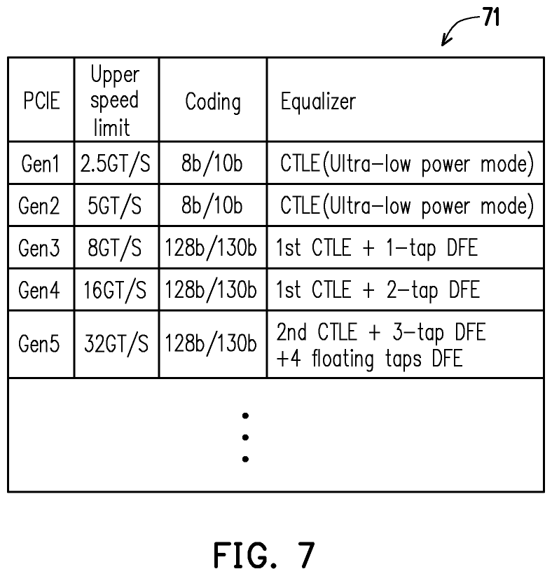

FIG. 7 is a schematic diagram of basic specifications of various connection interface standards shown according to an exemplary embodiment of the invention. Please refer to FIG. 7, in an exemplary embodiment, a table 71 records basic specifications of various connection interface standards that the connection interface unit 41 may adopt. For example, the information in Table 71 may present the upper limit of data transfer per unit time of the memory storage device 10 (or the connection interface unit 41), the coding rule adopted by the connection interface unit 41, and the equalizer setting of the connection interface unit 41 under different connection interface standards.

For example, when the connection interface standard adopted by the connection interface unit 41 is PCIE Gen 1, the upper limit of data transfer per unit time of the connection interface unit 41 is 2.5 GT/s (gigatransfer per second), the coding rule adopted by the connection interface unit 41 is 8b/10b (that is, in the transferred data, 8 bits out of 10 bits are valid bits), and the equalizer of the connection interface unit 41 is set to enable a continuous-time linear equalizer (CTLE) operated in an ultra-low power consumption mode. When the connection interface standard adopted by the connection interface unit 41 is PCIE Gen 3, the upper limit of data transfer per unit time of the connection interface unit 41 is 8 GT/s (gigatransfer per second), the coding rule adopted by the connection interface unit 41 is 128b/130b (that is, in the transferred data, 128 bits out of 130 bits are valid bits), and the equalizer of the connection interface unit 41 is set to enable the first (1st) CTLE and 1-tap decision feedback equalizer (DFE). Moreover, when the connection interface standard adopted by the connection interface unit 41 is PCIE Gen 5, the upper limit of data transfer per unit time of the connection interface unit 41 is 32 GT/s (gigatransfer per second), the coding rule adopted by the connection interface unit 41 is 128b/130b (that is, in the transferred data, 128 bits out of 130 bits are valid bits), and the equalizer of the connection interface unit 41 is set to enable the second (2nd) CTLE, 3-tap DFE, and 4 floating taps DFE, and so on. However, in an exemplary embodiment, all the information in Table 71 may be adjusted according to practical requirements, and the invention is not limited thereto.

It should be noted that, in general, when the connection interface unit 41 is operated in PCIE Gen i, the heat generation per unit time and power consumption per unit time of the memory storage device 10 may be respectively higher than the heat generation per unit time and the power consumption per unit time of the memory storage device 10 when the connection interface unit 41 is operated in PCIE Gen j, wherein i is greater than j. For example, PCIE Gen i may be PCIE Gen 5, and PCIE Gen j may be PCIE Gen 1, and the invention is not limited thereto.

In an exemplary embodiment, by adjusting the connection interface unit 41 currently operated in PCIE Gen i to operate in PCIE Gen j, the temperature, heat generation per unit time, and/or power consumption per unit time of the memory storage device 10 may be reduced, but at the same time, the upper limit of data transfer per unit time of the connection interface unit 41 is also reduced. Moreover, in an exemplary embodiment, by adjusting the connection interface unit 41 currently operated in PCIE Gen j to operate in PCIE Gen i, the upper limit of data transfer per unit time of the connection interface unit 41 may be increased without exceeding the standard temperature.

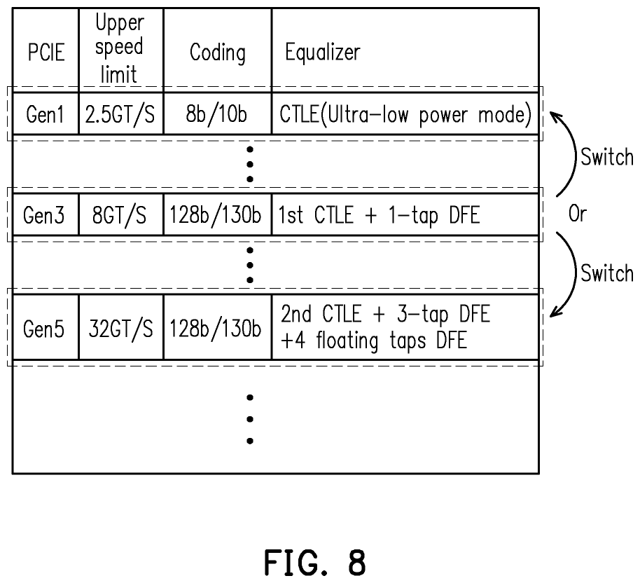

FIG. 8 is a schematic diagram of adjusting a connection interface standard adopted by a connection interface unit shown according to an exemplary embodiment of the invention. Referring to FIG. 8, in an exemplary embodiment, according to the device status information, the memory management circuit 51 may switch the connection interface standard adopted by the connection interface unit 41 from the first connection interface standard (such as PCIE Gen 3) to the second connection interface standard (such as PCIE Gen 1 or Gen 5).

In an exemplary embodiment, the memory management circuit 51 may dynamically determine the most suitable connection interface standard according to the device status information and instruct the connection interface unit 41 to adopt the connection interface standard. Accordingly, the memory management circuit 51 may attempt to reduce the power consumption per unit time of the memory storage device 10 and increase the data transfer speed of the memory storage device 10 as much as possible under the premise of not exceeding the specified temperature. Thereby, optimal balance may be achieved among the temperature (or heat generation per unit time), power consumption (or power consumption per unit time), and data transfer speed of the memory storage device 10, thereby improving the operating stability of the memory storage device 10.

In an exemplary embodiment, in response to the adjustment of the connection interface standard, the upper limit of data transfer per unit time of the memory storage device 10, the coding rule adopted by the connection interface unit 41, and/or the equalizer setting of the connection interface unit 41 may also be adjusted accordingly. For example, in an exemplary embodiment, in response to the adjustment of the connection interface standard, the memory management circuit 51 may enable or disable at least one circuit in the connection interface unit 41 to meet the specification of the adopted connection interface standard (e.g., the second connection interface standard).

It should be noted that, in the above exemplary embodiment, the memory management circuit 51 adjusts the upper limit of data transfer per unit time of the memory storage device 10, the coding rule adopted by the connection interface unit 41, and/or the equalizer setting of the connection interface unit 41 according to the adopted connection interface standard (i.e., the new connection interface standard) after dynamically determining the connection interface standard adopted by the connection interface unit 41. In this case, the adjusted settings meet the basic specifications of the adopted connection interface standard (i.e., the new connection interface standard), as shown in FIG. 7 or FIG. 8.

In an exemplary embodiment, the memory management circuit 51 may also dynamically adjust the upper limit of data transfer per unit time of the memory storage device 10, the coding rule adopted by the connection interface unit 41, and/or the equalizer setting of the connection interface unit 41 further according to the device status information on the basis of the adopted connection interface standard. In this case, some of the adjusted settings may be different from the basic specifications of the connection interface standard currently adopted by the connection interface unit 41. In an exemplary embodiment, such adjustment may further reduce the power consumption per unit time of the memory storage device 10 and/or increase the data transfer speed of the memory storage device 10 under the premise of not exceeding the standard temperature.

In an exemplary embodiment, according to the device status information, the memory management circuit 51 may determine, under the connection interface standard currently adopted by the connection interface unit 41, whether there is still any possibility of reducing the temperature (or heat generation per unit time) of the memory storage device 10, reducing the power consumption per unit time of the memory storage device 10, and/or increasing the data transfer speed of the memory storage device 10. If yes, the memory management circuit 51 may readjust at least one of the above settings, such as adjusting the upper limit of data transfer per unit time of the memory storage device 10, the coding rule adopted by the connection interface unit 41, and/or the equalizer setting of the connection interface unit 41. If not, the memory management circuit 51 may not perform any setting adjustments. Accordingly, the memory management circuit 51 may attempt to reduce the power consumption per unit time of the memory storage device 10 and/or increase the data transfer speed of the memory storage device 10 as much as possible under the premise of not exceeding the specified temperature.

In an exemplary embodiment, in the case that the connection interface unit 41 adopts the first connection interface standard, the memory management circuit 51 may adjust the upper limit of data transfer per unit time of the memory storage device 10 (or the connection interface unit 41) from the first upper limit of data transfer per unit time to another upper limit of data transfer per unit time (also known as third upper limit of data transfer per unit time) according to the device status information. The second upper limit of data transfer per unit time is different from the third upper limit of data transfer per unit time.

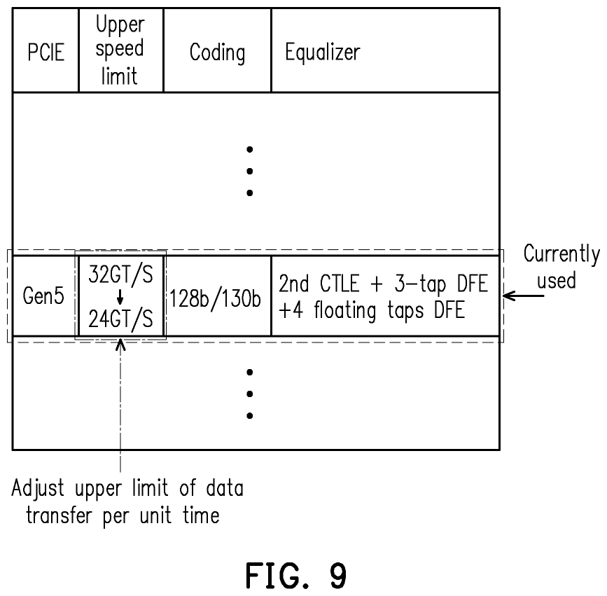

FIG. 9 is a schematic diagram of further adjusting the upper limit of data transfer per unit time when a specific connection interface standard is adopted shown according to an exemplary embodiment of the invention. Referring to FIG. 9, in an exemplary embodiment, according to the device status information, the memory management circuit 51 may further adjust the upper limit of data transfer per unit time of the memory storage device 10 based on the connection interface standard (for example, PCIE Gen 5) currently adopted by the connection interface unit 41. For example, when the connection interface unit 41 adopts PCIE Gen 5 as the connection interface standard, according to the device status information, the memory management circuit 51 may further adjust the upper limit of data transfer per unit time of the memory storage device 10, for example, reduced from 32 GT/s to 24 GT/s, and the rest of the parameters (such as coding method and equalizer setting) may be kept consistent with the basic setting of PCIE Gen 5. Accordingly, the memory management circuit 51 may attempt to further reduce the heat generation per unit time and/or the power consumption per unit time of the memory storage device 10 in the case of adopting PCIE Gen 5 and not affecting the actual data transfer per unit time of the memory storage device 10. Moreover, in an exemplary embodiment, according to the device status information, the memory management circuit 51 may also further adjust the coding rule and/or equalizer settings adopted by the connection interface unit 41 based on the connection interface standard (for example, PCIE Gen 5) currently adopted by the connection interface unit 41, and the invention is not limited thereto.

In an exemplary embodiment, according to the data transfer per unit time of the memory storage device 10 reflected by the performance information, the memory management circuit 51 may adjust the connection interface standard adopted by the connection interface unit 41. Using FIG. 7 as an example, it is assumed that the connection interface standard currently adopted by the connection interface unit 41 is PCIE Gen 5, but the performance information reflects that the data transfer per unit time of the memory storage device 10 is about 1.5 GT/s (which is significantly less than the upper limit of data transfer speed specified by PCIE Gen 5). In this case, the memory management circuit 51 may switch the connection interface standard adopted by the connection interface unit 41 from PCIE Gen 5 to PCIE Gen 1 according to the performance information (or the device status information). Accordingly, the power consumption per unit time and/or temperature (or heat generation per unit time) of the memory storage device 10 may be effectively reduced under the premise of not affecting the actual data transfer per unit time of the memory storage device 10. Or, in an exemplary embodiment, the memory management circuit 51 may also achieve the effect of reducing the power consumption per unit time and/or temperature (or heat generation per unit time) of the memory storage device 10 under the premise of not affecting the actual data transfer per unit time of the memory storage device 10 by reducing the upper limit of data transfer per unit time of the connection interface unit 41 (as shown in FIG. 9) or other settings without changing the currently adopted connection interface standard (for example, maintaining the connection interface standard adopted by the connection interface unit 41 at PCIE Gen 5).

In an exemplary embodiment, the memory management circuit 51 may adjust the above settings via table lookup, artificial intelligence model, and/or algorithm. For example, the memory management circuit 51 may input at least one of the temperature information, the performance information, and the power consumption information into a data table, an artificial intelligence model, and/or an algorithm. Then, the memory management circuit 51 may perform the above adjustment according to the output of the data table, the artificial intelligence model, and/or the algorithm. It should be noted that the data table, the artificial intelligence model, and/or the algorithm may be designed according to practical needs, and the invention is not limit thereto. Thereby, the memory management circuit 51 may obtain optimal balance among the temperature (or heat generation per unit time), power consumption (or power consumption per unit time), and data transfer speed of the memory storage device 10 as much as possible, thereby improving the operating stability of the memory storage device 10.

In an exemplary embodiment, the memory management circuit 51 may also adjust other parameters inside the memory storage device 10 according to the device status information, depending on practical requirements. For example, the parameters may affect the system clock of the memory storage device 10, the programming mode (e.g., SLC mode, MLC mode, TLC mode, or QLC mode) for storing data into the rewritable non-volatile memory module 43, or the internal software/hardware configuration (e.g., using SRAM or DRAM as cache memory) of the memory storage device 10, etc., as long as better balance among the temperature (or heat generation per unit time), power consumption (or power consumption per unit time), and data transfer speed of the memory storage device 10 may be achieved and/or the operating stability of the memory storage device 10 may be improved.

In an exemplary embodiment, according to the device status information, the memory management circuit 51 may also obtain information related to whether the memory storage device 10 is performing a specific operation (also called a default operation). For example, during the period when the memory storage device 10 performs the default operation, the data transfer per unit time of the memory storage device 10 may be affected by the default operation. For example, the default operation may include at least one of a data merging operation, a wear leveling operation, and a data refreshing operation.

In an exemplary embodiment, the data merging operation may be used to copy valid data from one physical unit (also called source unit) to another physical unit (also known as target unit) in the rewritable non-volatile memory module 43, so as to release new spare physical units. For example, the released spare physical units may be added to the spare area 602 of FIG. 6 to increase the total number of physical units in the spare area 602. For example, the data merging operation may include a garbage collection operation.

In an exemplary embodiment, the wear leveling operation is also used to copy valid data from one physical unit (i.e., source unit) to another physical unit (i.e., target unit) in the rewritable non-volatile memory module 43. However, different from the data merging operation, the wear leveling operation is used to perform wear leveling on a plurality of physical units with different loss levels in the rewritable non-volatile memory module 43. For example, the loss balance may refer to the balance of programming times, erasing times, and/or reading times among a plurality of physical units.

In an exemplary embodiment, the data refreshing operation is also used to copy valid data from one physical unit (i.e., source unit) to another physical unit (i.e., target unit) in the rewritable non-volatile memory module 43. However, unlike the data merging operation (and/or the wear leveling operation), the data refreshing operation is used to rewrite the data with higher bit error rate in the source unit to the target unit, so as to reduce the bit error rate of the data. In an exemplary embodiment, the default operation may also include other types of operations, and the invention is not limited thereto.

In an exemplary embodiment, during the period when the memory storage device 10 performs the default operation, the data transfer per unit time of the memory storage device 10 may be affected by the default operation and be reduced. At this point, even though the connection interface standard currently adopted by the connection interface unit 41 (such as PCIE Gen 5) may have a higher upper limit of data transfer speed, but affected by the default operation, the actual data transfer per unit time of the memory storage device 10 often may not reach the expected maximum data transfer speed.

In an exemplary embodiment, the memory management circuit 51 may determine whether the memory storage device 10 is performing the default operation according to the device status information. In response to the memory storage device 10 performing the default operation, the memory management circuit 51 may adjust the connection interface standard (for example, adjust the connection interface standard adopted by the connection interface unit 41 from PCIE Gen 5 to PCIE Gen 1) adopted by the connection interface unit 41 and/or adjust the above settings. Accordingly, the temperature (or heat generation per unit time) and/or power consumption (or power consumption per unit time) of the memory storage device 10 may be reduced synchronously during the period when the memory storage device 10 performs the default operation causing the data transfer speed to be decreased.

In an exemplary embodiment, in response to the completion of the default operation (and/or the device status information), the memory management circuit 51 may restore the memory storage device 10 to the previous operating status, for example, restore the connection interface standard adopted by the connection interface unit 41 from PCIE Gen 1 to PCIE Gen 5 and/or adjust the above settings. In other words, the memory management circuit 51 may obtain optimal balance among the temperature (or heat generation per unit time), power consumption (or power consumption per unit time), and data transfer speed of the memory storage device 10 as much as possible according to the execution and termination of the default operation, thereby improving the operating stability of the memory storage device 10.

In an exemplary embodiment, the memory management circuit 51 may perform feedback control or feedback adjustment on the memory storage device 10 according to the device status information, so as to find the best setting parameter (or parameter group) of the memory storage device 10 in a specific status. Then, in the specific status, the memory management circuit 51 may control the operation of the memory storage device 10 according to the optimal setting parameter (or parameter group). For example, the optimal setting parameter (or parameter group) may make the memory storage device 10 achieve the best balance among temperature (or heat generation per unit time), power consumption (or power consumption per unit time), and data transfer speed, thereby improving the operating stability of the memory storage device 10.

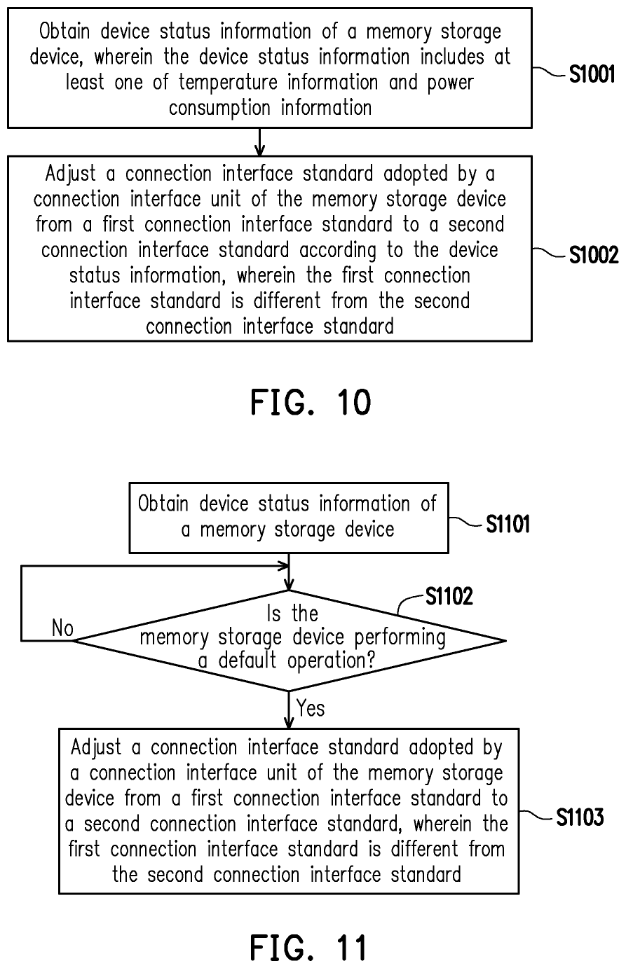

FIG. 10 is a flowchart of a device control method shown according to an exemplary embodiment of the invention. Referring to FIG. 10, in step S1001, device status information of a memory storage device is obtained, wherein the device status information includes at least one of temperature information and power consumption information. In step S1002, a connection interface standard adopted by the connection interface unit of the memory storage device is adjusted from a first connection interface standard to a second connection interface standard according to the device status information, wherein the first connection interface standard is different from the second connection interface standard.

FIG. 11 is a flowchart of a device control method shown according to an exemplary embodiment of the invention. Referring to FIG. 11, in step S1101, device status information of a memory storage device is obtained. In step S1102, whether the memory storage device is performing a default operation is determined. If the memory storage device is performing the default operation, in step S1103, a connection interface standard adopted by a connection interface unit of the memory storage device is adjusted from a first connection interface standard to a second connection interface standard, wherein the first connection interface standard is different from the second connection interface standard. In addition, if the memory storage device is not performing the default operation, step S1101 may be repeated.

However, each step in FIG. 10 and FIG. 11 is as described in detail above, and is not repeated herein. It should be mentioned that, each step in FIG. 10 and FIG. 11 may be implemented as a plurality of program codes or circuits, and the invention is not limited thereto. Moreover, the method of FIG. 10 and FIG. 11 may be used with the above exemplary embodiments, and may also be used alone, and the invention is not limited thereto.

Based on the above, the device control method, the memory storage device, and the memory control circuit unit proposed by the exemplary embodiments of the invention may, according to the device status information monitored in real time, dynamically adjust the settings of the memory storage device, such as adjust the connection interface standard adopted by the connection interface unit, adjust the upper limit of data transfer per unit time of the memory storage device, adjust the coding rule adopted by the connection interface unit, adjust the equalizer setting of the connection interface unit, and/or enable or disable at least one circuit in the connection interface unit, etc. Thereby, balance may be achieved among the temperature (or heat generation per unit time), power consumption (or power consumption per unit time), and data transfer speed of the memory storage device as much as possible, thereby improving the operating stability of the memory storage device.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A device control method, configured for a memory storage device, wherein the memory storage device comprises a connection interface unit, the connection interface unit is configured to be coupled to a host system, and the device control method comprises:
obtaining device status information of the memory storage device, wherein the device status information comprises at least one of temperature information and power consumption information; and
adjusting a connection interface standard adopted by the connection interface unit from a first connection interface standard to a second connection interface standard according to the device status information, wherein the first connection interface standard is different from the second connection interface standard.

2. The device control method of claim 1, wherein the temperature information reflects a temperature of the memory storage device, and the power consumption information reflects a power consumption per unit time of the memory storage device.

3. The device control method of claim 1, wherein when the connection interface unit adopts the first connection interface standard, the memory storage device has a first upper limit of data transfer per unit time,
when the connection interface unit adopts the second connection interface standard, the memory storage device has a second upper limit of data transfer per unit time, wherein the first upper limit of data transfer per unit time is different from the second upper limit of data transfer per unit time.

4. The device control method of claim 3, further comprising:
adjusting an upper limit of data transfer per unit time of the memory storage device from the first upper limit of data transfer per unit time to a third upper limit of data transfer per unit time according to the device status information when the connection interface unit adopts the first connection interface standard, wherein the second upper limit of data transfer per unit time is different from the third upper limit of data transfer per unit time.

5. The device control method of claim 1, wherein the connection interface standard adopted by the connection interface unit comprises at least two of a first generation, a second generation, a third generation, a fourth generation, and a fifth generation of a PCI Express standard.

6. The device control method of claim 1, wherein the device status information further comprises performance information, and the performance information reflects a data transfer per unit time between the memory storage device and the host system.

7. The device control method of claim 1, wherein the step of adjusting the connection interface standard adopted by the connection interface unit from the first connection interface standard to the second connection interface standard according to the device status information comprises:
enabling or disabling at least one circuit in the connection interface unit according to the device status information.

8. The device control method of claim 1, wherein the step of adjusting the connection interface standard adopted by the connection interface unit from the first connection interface standard to the second connection interface standard according to the device status information comprises:
adjusting a coding rule adopted by the connection interface unit according to the device status information.

9. The device control method of claim 1, wherein the device status information also reflects whether the memory storage device is performing a default operation, and the step of adjusting the connection interface standard adopted by the connection interface unit from the first connection interface standard to the second connection interface standard according to the device status information comprises:
adjusting the connection interface standard adopted by the connection interface unit from the first interface standard to the second interface standard in response to the memory storage device performing the default operation, wherein the default operation comprises at least one of a data merging operation, a wear leveling operation, and a data refreshing operation.

10. A memory storage device, comprising:
a connection interface unit configured to be coupled to a host system;
a rewritable non-volatile memory module;
a memory control circuit unit coupled to the connection interface unit and the rewritable non-volatile memory module,
wherein the memory control circuit unit is configured to:
obtain device status information of the memory storage device, wherein the device status information comprises at least one of temperature information and power consumption information; and
adjust a connection interface standard adopted by the connection interface unit from a first connection interface standard to a second connection interface standard according to the device status information, wherein the first connection interface standard is different from the second connection interface standard.

11. The memory storage device of claim 10, wherein the temperature information reflects a temperature of the memory storage device, and the power consumption information reflects a power consumption per unit time of the memory storage device.

12. The memory storage device of claim 10, wherein when the connection interface unit adopts the first connection interface standard, the memory storage device has a first upper limit of data transfer per unit time,
when the connection interface unit adopts the second connection interface standard, the memory storage device has a second upper limit of data transfer per unit time, wherein the first upper limit of data transfer per unit time is different from the second upper limit of data transfer per unit time.

13. The memory storage device of claim 12, wherein the memory control circuit unit is further configured to:
adjust an upper limit of data transfer per unit time of the memory storage device from the first upper limit of data transfer per unit time to a third upper limit of data transfer per unit time according to the device status information when the connection interface unit adopts the first connection interface standard, wherein the second upper limit of data transfer per unit time is different from the third upper limit of data transfer per unit time.

14. The memory storage device of claim 10, wherein the connection interface standard adopted by the connection interface unit comprises at least two of a first generation, a second generation, a third generation, a fourth generation, and a fifth generation of a PCI Express standard.

15. The memory storage device of claim 10, wherein the device status information further comprises performance information, and the performance information reflects a data transfer per unit time between the memory storage device and the host system.

16. The memory storage device of claim 10, wherein the operation of the memory control circuit unit adjusting the connection interface standard adopted by the connection interface unit from the first connection interface standard to the second connection interface standard according to the device status information comprises:
enabling or disabling at least one circuit in the connection interface unit according to the device status information.

17. The memory storage device of claim 10, wherein the operation of the memory control circuit unit adjusting the connection interface standard adopted by the connection interface unit from the first connection interface standard to the second connection interface standard according to the device status information comprises:
adjusting a coding rule adopted by the connection interface unit according to the device status information.

18. The memory storage device of claim 10, wherein the device status information also reflects whether the memory storage device is performing a default operation, and the operation of the memory control circuit unit adjusting the connection interface standard adopted by the connection interface unit from the first connection interface standard to the second connection interface standard according to the device status information comprises:
adjusting the connection interface standard adopted by the connection interface unit from the first interface standard to the second interface standard in response to the memory storage device performing the default operation, wherein the default operation comprises at least one of a data merging operation, a wear leveling operation, and a data refreshing operation.

19. A memory control circuit unit, configured to control a memory storage device, wherein the memory storage device comprises a connection interface unit, the connection interface unit is configured to be coupled to a host system, and the memory control circuit unit comprises:
a host interface configured to be coupled to the host system;
a memory interface configured to be coupled to the rewritable non-volatile memory module; and
a memory management circuit coupled to the host interface and the memory interface,
wherein the memory management circuit is configured to:
obtain device status information of the memory storage device, wherein the device status information comprises at least one of temperature information and power consumption information; and
adjust a connection interface standard adopted by the connection interface unit from a first connection interface standard to a second connection interface standard according to the device status information, wherein the first connection interface standard is different from the second connection interface standard.

20. The memory control circuit unit of claim 19, wherein the temperature information reflects a temperature of the memory storage device, and the power consumption information reflects a power consumption per unit time of the memory storage device.

21. The memory control circuit unit of claim 19, wherein when the connection interface unit adopts the first connection interface standard, the memory storage device has a first upper limit of data transfer per unit time,
when the connection interface unit adopts the second connection interface standard, the memory storage device has a second upper limit of data transfer per unit time, wherein the first upper limit of data transfer per unit time is different from the second upper limit of data transfer per unit time.

22. The memory control circuit unit of claim 21, wherein the memory management circuit is further configured to:
adjust an upper limit of data transfer per unit time of the memory storage device from the first upper limit of data transfer per unit time to a third upper limit of data transfer per unit time according to the device status information when the connection interface unit adopts the first connection interface standard, wherein the second upper limit of data transfer per unit time is different from the third upper limit of data transfer per unit time.

23. The memory control circuit unit of claim 19, wherein the connection interface standard adopted by the connection interface unit comprises at least two of a first generation, a second generation, a third generation, a fourth generation, and a fifth generation of a PCI Express standard.

24. The memory control circuit unit of claim 19, wherein the device status information further comprises performance information, and the performance information reflects a data transfer per unit time between the memory storage device and the host system.

25. The memory control circuit unit of claim 19, wherein the operation of the memory management circuit adjusting the connection interface standard adopted by the connection interface unit from the first connection interface standard to the second connection interface standard according to the device status information comprises:
enabling or disabling at least one circuit in the connection interface unit according to the device status information.

26. The memory control circuit unit of claim 19, wherein the operation of the memory management circuit adjusting the connection interface standard adopted by the connection interface unit from the first connection interface standard to the second connection interface standard according to the device status information comprises:
adjusting a coding rule adopted by the connection interface unit according to the device status information.

27. The memory control circuit unit of claim 19, wherein the device status information also reflects whether the memory storage device is performing a default operation, and the operation of the memory management circuit adjusting the connection interface standard adopted by the connection interface unit from the first connection interface standard to the second connection interface standard according to the device status information comprises:
adjusting the connection interface standard adopted by the connection interface unit from the first interface standard to the second interface standard in response to the memory storage device performing the default operation, wherein the default operation comprises at least one of a data merging operation, a wear leveling operation, and a data refreshing operation.
